(19) United States
(12) Patent Application Publication
(10) Pub. No.: US 2022/0302875 A1
(43) Pub. Date: Sep. 22, 2022

(54) Flat Tile Solar Panels-Module Number

(71) Applicant: Erthos IP LLC, Tempe, AZ (US)

(72) Inventors: James Scott TYLER, Queen Creek, AZ (US); Willie HAMMACK, Flagstaff, AZ (US); Michael GLADKIN, Tempe, AZ (US)

(21) Appl. No.: 17/836,868

(22) Filed: Jun. 9, 2022

Related U.S. Application Data
(63) Continuation-in-part of application No. 16/682,517, filed on Nov. 13, 2019.
(60) Provisional application No. 62/903,369, filed on Sep. 20, 2019.

(51) Int. Cl. H02S 40/36; H02S 20/32; H02S 20/10; H02S 40/32; H02S 40/10

(52) U.S. Cl. CPC H02S 40/36; H02S 20/32; H02S 20/10; H02S 40/32; H02S 40/10; H02S 10/00

(57) ABSTRACT

An earth-mount utility-scale solar photovoltaic array has modules supported on the ground to establish an earth orientation of the modules. These modules sit in a closely adjacent arrangement or an abutting arrangement of module rows. One general aspect includes a utility-scale group of modules that contains greater than 800 conterminous PV modules in which more than 80% of the modules are earth-mounted. Implementations may include the array having one or more of the following features: eight groups of modules; no connection to an inverter with an ac output; no stowing functionality or extreme dampening functionality. Implementations of the described techniques may include solar arrays and related methods.

### RELATED APPLICATION(S)

This application is a continuation-in-part of U.S. patent application Ser. No. 16/682,517, filed Nov. 13, 2019, pending; application Ser. No. 16/682,517 claims priority to Provisional Patent Application No. 62/903,369, filed Sep. 20, 2019. Both of these applications are incorporated into this document by this reference.

### BACKGROUND

### Technical Field

The disclosed technology uses a terrestrial or ground-based mounting system to mount solar modules.

### Background Art

Solar modules are assemblies of multiple photovoltaic (PV) cells wired to form a single unit, typically rigid but sometimes flexible. Multiple solar modules can be wired together in series to form an array of strings. These strings connect to a power receiving unit that provides power, typically an inverter or other controller, that provides power. One or more solar arrays compose a solar plant.

Utility-scale solar PV power plants differ from other solar power and electricity installations. Due to the size, energy cost, safety regulations, and operating requirements of utility-scale power plants, the components, hardware design, construction means and methods, operations, and maintenance all have specific, unique features earning the designation utility-scale.

Power production with modules has been expensive because PV cells within the module have been expensive to manufacture and highly inefficient. But over the past 40 years, advances in module manufacturing have lowered PV electricity costs.

When PV cells were expensive, significant costs were incurred to correctly position the modules vis-à-vis the sun to maximize energy production. At first, dual-axis trackers positioned PV arrays substantially perpendicular to the sun's rays throughout the day and the year. Dual-axis trackers are expensive and difficult to maintain. But they maximized the energy output of the much more expensive photovoltaics.

As module prices fell and efficiency improved, dual-axis trackers became less necessary. And less expensive fixed-tilt trackers and single-axis trackers were employed to lower costs. Fixed-tilt and single-axis trackers are also expensive and difficult to maintain but less so than dual-axis trackers. Further developments included adapting these newer systems for rooftop mounting on home, office, commercial, and industrial buildings. Fixed-tilt and single-axis tracking methods are often categorized as ground mount technologies, separating them from roof-mount technologies. Ground mount means the modules are supported by free-standing structures with dedicated foundations rather than a building.

Large solar farms have used dual-axis, fixed-tilt, and single-axis trackers in large solar farms to point solar modules toward the sun. Some systems also account for solar elevation or otherwise account for the effect of the sun's analemma. These systems increase efficiency by aligning the modules normal to the sunlight and utilizing the solar cells' physical area more efficiently.

Modules are generally waterproof and durable. For example, modules commonly withstand hail of up to 25 mm (one inch), falling at 23 m/sec.

While modules accumulate dust, as a practical matter, racked solar modules are not cleaned very often because the expected energy return from removing accumulated dirt and dust doesn't offset the cleaning expense.

Conceptually, a solar array, or a portion of an entire solar plant, could be series-wired to provide electrical power at a transmission voltage. But the need to segment a solar plant for redundancy, maintenance, and avoiding arcing to the ground calls for voltage limiting the solar modules because of potential arcing through the glass and backing. In typical configurations, the array output voltage is 1500 volts, with lower voltages such as 600 volts for residential applications. Therefore, conventionally, solar arrays are voltage limited. Modules sit in groups called strings to limit the voltage. Strings, in turn, connect to inverters with harnesses of varying configurations according to the length of the strings and other considerations.

The harnesses themselves are expensive. Since the system is voltage limited, the total power output of the plant translates to substantial wiring costs. Similarly, power losses through the wiring harness translate to additional costs. Therefore, configurations that reduce harness length are desirable.

One harness configuration used with racked modules is called skip stringing or leapfrog wiring. In skip stringing, harnesses bypass alternate modules to provide efficient wiring by limiting cabling to approximately the distance between alternating modules.

The ability to achieve connections extending over a longer distance without a proportional increase in cabling allows positive and negative connections to be placed closer to the inverter, reducing the length of harness wires needed to connect to the inverter. In addition, since the modules alternately connect, the alternate modules within the same physical row can provide a return circuit, thereby reducing the distance between an end module and the inverter. Ideally, one positive or negative pole connecting the string to the inverter is only one module length away from the other pole. This arrangement reduces home run wire length but requires that each link skip alternate modules to return along the same row.

This system of stringing accommodates the polarities of the modules; however, this technique still requires wiring harnesses in the connection. In addition, these techniques still require additional harnesses to connect the respective ends of the strings and the inverter.

Finally, since adjacent rows of modules are separated by a space corresponding to the cast shadow of racked modules, it becomes impractical to string modules across rows.

Wind presents another problem with racked or tracker-mounted solar modules. High expected wind forces often significantly increase the cost of constructing solar power plants. And high winds easily damage the modules themselves, requiring expensive upkeep. Wind-induced cyclic loading also can lead to microcracking, which has become a significant issue for the industry, influencing long-term module warranties.

Racks and tracker mounts also suffer from exposure to soils and corrosive air. For example, typical power plants use steel piles. To support the small, sail-like mounted arrays, these piles must resist corrosion for a long time, frequently 25 or more years despite corrosion.

### SUMMARY

An earth-mount utility-scale solar photovoltaic array has modules supported on the ground to establish an earth orientation of the modules. These modules sit in a closely adjacent arrangement or an abutting arrangement of module rows. One general aspect includes a utility-scale group of modules that contains greater than 800 conterminous PV modules in which more than 80% of the modules are earth-mounted.

Some implementations relate to photovoltaic power plants having a utility-scale group of modules where a group of modules contains greater than 800 conterminous PV modules in which more than 80% of the modules are earth-mounted.

The described implementations may also include one or more of the following features. A plant having two or more groups of modules. A plant having greater than 1600 conterminous modules. A plant may include a fully autonomous cleaning robot. A plant where the fully autonomous cleaning robot is an AI autonomous robotic device. A plant where some modules have a contact region that rests on the ground or a contact surface of one or more structures, provided that the volume beneath and perpendicular to the contact surface is solid or constrains air movement. A plant having eight or more groups of modules. A plant having an inverter with an AC output, where the array has a DC output, and the DC:AC ratio is 1.21.9, 1.41.9, or 1.62.2. A plant having 100-200 inverters. A plant where one of the arrays has 50 or more rows of modules. A plant where one of the arrays has 50 or more columns of conterminous modules. A plant may include a fully autonomous cleaning robot. A plant where some or all groups of modules do not connect to an inverter. A plant where some or all groups of modules do not connect to an inverter with an AC output. A plant with some or all groups of modules having an arrangement that withstands wind speeds greater than 150 mph. A plant where some or all modules or groups of modules do not contain stowing functionality or extreme dampening functionality.

### BRIEF DESCRIPTION OF THE DRAWINGS

FIG. 1 is a schematic perspective view of a module array.

FIG. 2 is another schematic perspective view of a module.

FIG. 3 is a schematic cross-section of a module array.

FIG. 4 is a schematic cross-section of a module array with a prior art module mount.

FIG. 5 is a schematic side view of the prior art mount of FIG. 4.

FIG. 6 is a schematic view of prior art structures used to mount trackers or modules.

FIG. 7 is a schematic cross-section of another module array.

FIG. 8 is a perspective view of a laminated cable assembly.

FIG. 9 is a perspective view of a leading edge.

FIG. 10 is another perspective view of a leading edge.

FIG. 11 is a perspective view of an extruded leading edge with cable assembly.

FIG. 12 is a schematic view of alternative ground-mounted structures.

FIG. 13 is another schematic view of alternative ground-mounted structures.

FIG. 14 is another schematic view of alternative ground-mounted structures.

FIG. 15 is a perspective view of a module with a connecting cable.

FIG. 16 is a magnified cross-section view of the module of FIG. 15.

FIG. 17 is another perspective view of a module with a connecting cable.

FIG. 18 is a schematic side view of a string of modules with a connecting cable.

FIG. 19 is a magnified view of a connection between the modules of FIG. 18.

FIG. 20 is a magnified view of another connection between the modules of FIG. 18.

FIG. 21 is a schematic diagram showing a solar array layout for a commercial solar power plant.

FIG. 22 is another schematic diagram showing a solar array layout for a commercial solar power plant.

FIG. 23 is another schematic diagram showing a solar array layout for a commercial solar power plant.

FIG. 24 is a perspective view of a robotic cleaning device.

FIG. 25 is a perspective view of the internals of a robotic cleaning device.

FIG. 26 is a graph showing an illustrative output for a single clear-sky day of a solar power plant operation.

### DETAILED DESCRIPTION

To the extent that the material doesn't conflict with the current disclosure, this disclosure incorporates by reference the entire contents of the following patent applications: Ser. No. 17/153,845; 63/120,931; 63/079,778; 63/021,825; 63/052,369; 63/052,367; 62/963,300; 17/152,663; 63/021,928; 62/903,369; 16/682,503; 16/682,517; 17/079,949; 63/172,599; 17/316,647; 17/316,535; 17/336,393; 17/336,404; 17/336,407; 17/336,417; 17/336,431; 17/336,442; 17/336,699; 17/337,234; and Ser. No. 17/337,240.

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that implementations exist for each component and any combination of the components—including combinations that specifically exclude any one or any combination of the listed components. For example, “component A is chosen from A, B, or C” discloses implementations with A, B, C, AB, AC, BC, and ABC. It also discloses (AB but not C), (AC but not B), and (BC but not A) as implementations, for example. Combinations that one of ordinary skill in the art knows to be incompatible with each other or with the components' function in the invention are excluded, in some implementations.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, and “upper” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted.

The description of the implementations has been provided for illustration and description. It is not intended to be exhaustive or to limit the invention. Individual elements or features of a particular implementation are not limited to that implementation but, where applicable, are interchangeable and can be used in a selected implementation, even if not explicitly shown or described. The same may also be varied. Such variations are not a departure from the invention, and all such modifications are included within the invention's scope.

### Components

solar module 9
substrate 10
frames 11
edge 12
module top face 14
penetrations, frame holes, or alignment holes 60
array 99
structure 205
module bottom 210
ground or grade 215
arrow 220
prior-art mechanical mount 229
L-bracket 230
rectangular bar bracket 235
contact surface 240
pier 310
ballasted piers 315
ballast piers 320
small ballasted piers 330
large ballast piers 340
positive connection 350
support object 410
object 420
laminated cable assembly (LCA) 500
upper sheet 520
sheet 530
cables 550
region 560
leading-edge units or curb member 600
depression 610
connecting cable 639
aggregate base 910
pier 920
post 930
cable attachment 940
DC-AC inverter 1015
crossover 1030
versions sometimes use bolts 1050
cavity 1055
solar array 1220
bridges 1233
lower gap 1310
upper gap 1320
flexible mechanical connections 1510
autonomous cleaning robot 1900
rear cover 1910
front cover 1920
wheels 1930
brush assembly 1940
brush 1950
brush motor 1960
transmission 1961
battery 2010
strings 2014
rear chassis 2020
front chassis 2030
electronic assembly 2060
first block 3012
second block 4012

Variations on utility-scale PV module electricity generating systems are disclosed. These systems are characterized by mounting some or all the modules substantially flat on the ground dispensing with tracker or racking structure (inclusively “racked” systems). Mounting modules flat on the ground results in the module orientation being directed by contact with the ground (Earth). Such an orientation is fundamentally different than the custom or semi-custom orientation that racking creates (sun-oriented).

This document provides a technique for generating electricity using either commercially available, utility-scale, solar (e.g., CSi, CdTe, CIGS, CIS) modules, or future adaptations of commercially available, utility-scale, solar modules, or new module technologies, a plurality of which contact the earth's surface and sit parallel to it. Earth mounting establishes a topographical orientation of the modules, as distinguished from a sun orientation in which the sun's direction dictates the modules' direction. “Earth mounting” is used synonymously with topographical mounting (T mounting) throughout this document.

The modules sit edge-to-edge, end-to-end, or both depending upon the implementation. T-mounted systems have a tiny exposure to air (wind) moving across their modules, allowing them to largely dispense with mounting hardware to hold system modules against the ground. T-mounted systems can withstand wind speeds of 150 mph without mounting hardware. But some embodiments use mounting hardware. Various methods of attaching the modules to the ground or each other are contemplated for arrays that use such optional connections. T mounting substantially reduces wind loading on the modules, avoiding high wind forces. T-mounted systems have low module elevations.

Also, T mounting provides significant advantages when used with commercially available string- or micro-inverters. But T mounting does not preclude using industry-standard central inverters or alternate power conversion and transmission technologies.

T mounting eliminates the need for the steel structures required by racked systems. Thus, T mounting eliminates structural corrosion and increases power plant life expectancy from 25 years to perhaps longer than 40 years while significantly reducing initial costs. Nonetheless, steel, coated or otherwise, can be used with the system. T-mounted systems frequently include commercially available and compatible new module cleaning or dust removal techniques.

T mounting can use commercially available and compatible new methods for module cooling from the backside of the modules, including evaporative cooling, alternate high-emissivity coatings, air-vented module frame edges, coatings with various added, enhanced heat-transfer materials, and or methods, thereby increasing the modules' effective energy production. T mounting also avoids indirect sunlight and sunlight-heated ground from heating the modules. Thus, the ground beneath the modules becomes a heat sink. In some implementations, the module backs are coated with a dark or heat-transmitting coating to promote heat transfer to the ground or airspace beneath the modules.

The shadows cast by racked systems extend far from the racking. To avoid shading adjacent panels, racked systems must be placed far apart. Site- or topographically oriented systems are much closer to the ground than racked systems, yielding little or no shadowing. Shadow-caused spacing in a T-mounted system is virtually zero, in some versions.

T mounting increases the power density per acre of land, which reduces the needed land area by more than 50% of traditional utility-scale solar plant PV power plants in some cases. T mounting allows the PV array to follow the land's existing contour, obviating the need for land preparation such as mass grading, plowing, tilling, cutting, and filling.

T mounting uses more modules than racked systems because racked systems point modules at the sun better. This yields higher output per module in racked systems, offset by savings achieved by foregoing the racking systems.

In some implementations, lower electrical losses due to wiring, lower energy losses due to module cleaning, lower costs (materials, construction, and real estate), shorter construction schedule, and lower risk offset increased module costs, ultimately leading to an overall reduction in produced energy price (LCOE) of greater than 10% over current technologies.

T mounting reduces wind loading and uplift forces, eliminates module-to-module shading, requires zero or minimal row spacing, and increases the ground coverage ratio. And it orients the modules parallel to existing topography, independent of a site's azimuth angle.

Modules are typically flat rectangles (or any other convenient space-filling shape). Various implementations modify module installation techniques to allow installation directly on the ground and are configured to take advantage of the ground's cooling and heat-sinking effects. Placing the modules sometimes includes using attachment brackets. In some implementations, the modules snap into or otherwise secure the attachment brackets, retaining the array on or near the ground. Ground placement avoids mounting the modules on racks and avoids shadows. No shadows mean no need for substantial spacing between modules. Some systems use a connecting cable system, such as disclosed in U.S. patent application Ser. No. 17/316,535.

In some implementations, modules may mount using attachment brackets, which sometimes connect adjacent modules. Some module installations include mounting components that secure adjacent modules vertically, horizontally, or both. Modules can be anchored to the ground. But since modules are not suspended aboveground at any significant angle to the horizontal, wind loading and wind uplift are substantially reduced or eradicated versus racked systems. Therefore, anchoring, including anchoring with brackets or otherwise, is unnecessary and is not always used.

In some implementations, brackets secure the modules to each other and maintain a substantially fixed module arrangement. Anchor stakes augment this stability but need only secure the modules against forces that the laid-flat (T-mounted) modules experience.

T-mounted systems can be constructed with little or no gaps between adjacent modules. Eliminating the gaps allows a two-dimensional array, when desired, of closely adjacent modules to extend row-wise and column-wise (from row to row). In other words, gaps between sequential modules from row to row can closely approximate gaps between sequential modules along the rows. Ultimately, modules in a T-mounted arrangement use far less land area than racked systems. In some implementations, T-mounted arrays use less than 50%, 45%, 40%, 35%, or 30% of the land area used by racked systems. Some implementations dispense with module-to-module mechanical connections. Some inter-module connections do not control the spacing between modules.

In some versions, this adjacent positioning allows wiring connections or harnesses to take advantage of the adjacent relationships across two or more rows, reducing wire lengths. In some implementations, adjacent positioning reduces home run harness lengths, commonly called whips.

Eliminating racking produces an additional wiring advantage. Since there are no racks, there is no need to extend rack lengths to limit string voltages. Removing this constraint, in turn, allows the strings to terminate at both ends of the strings (or on the same side of the array) close to the inverters, if desired. With multiple strings terminating close together, the inverters can sit close to the terminations of multiple strings.

In some versions, a contact surface defines a starting point of a pass-through structure pressure found and directly beneath the contact surface. In some implementations, “earth-mounted” means any mounting substantially parallel to the earth or ground that places the plane of the array within less than a short distance of the ground. This disclosure sometimes uses “ground-mounted” as a synonym for “earth-mounted”. Additionally, this disclosure sometimes uses “T-mounted” as a synonym for “earth-mounted”.

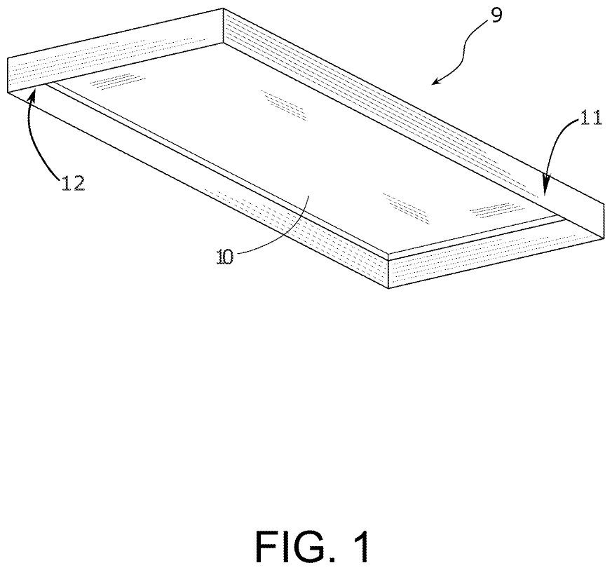

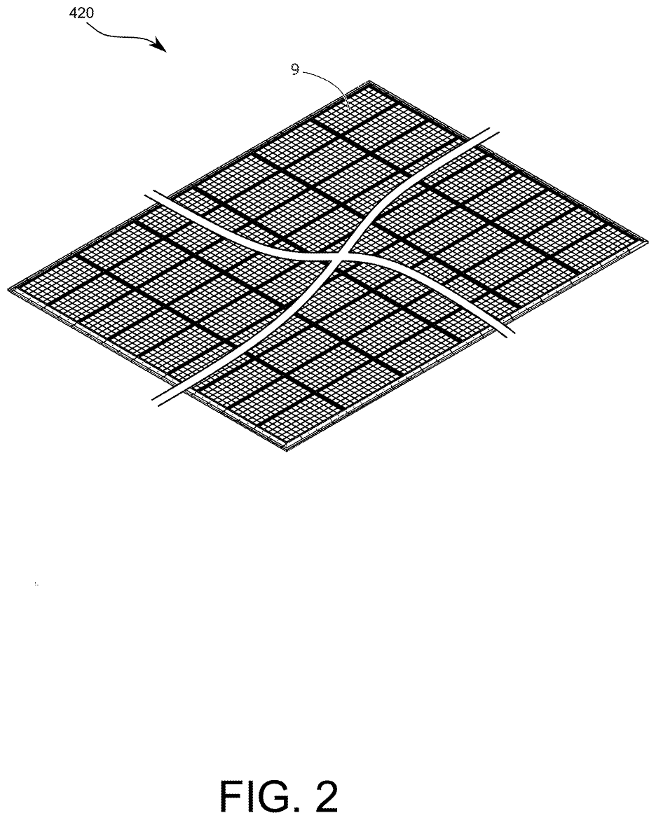

In part, FIG. 1 illustrates a schematic view of a photovoltaic solar module 9 having photovoltaic substrate 10, frames 11, edges 12, and module top face 14. Sometimes solar module 9 is frameless and does not have frames 11. FIG. 2 is a schematic view comprising many modules 9 assembled into utility-scale solar array 99 mounted flat on the ground following the topography. Some or all of the modules 9 are mounted to contact the ground. Depending upon the version, not all edges 12 touch the ground. This novel mounting type is sometimes called topography mounted, “T-mounted”, or topography oriented.

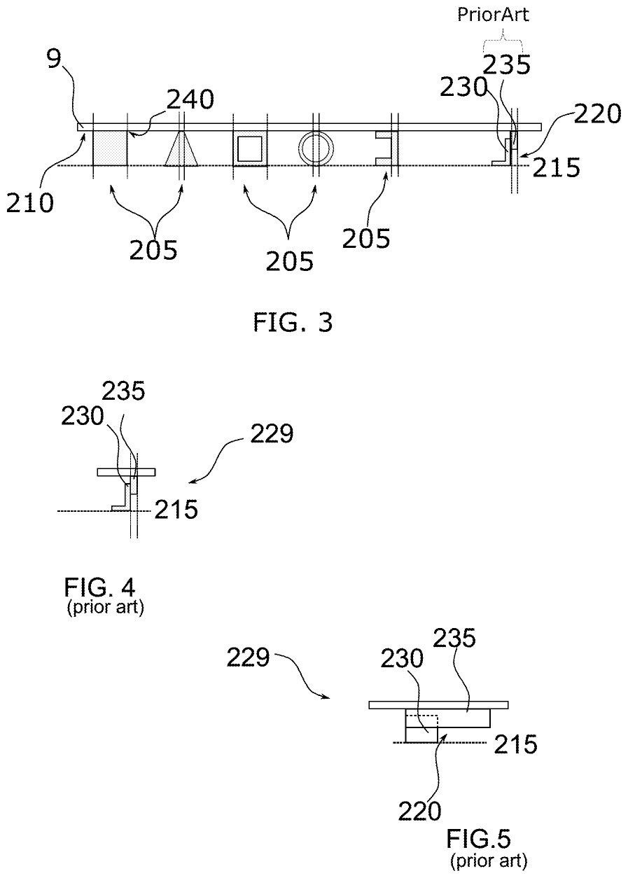

FIG. 3 shows versions of T-mounted systems with inconsequential objects between modules 9 and ground (grade 215) but not tracker objects or angled racking objects. As defined below, the inconsequential (in one way or another) objects are called structures.

FIG. 3 illustrates a cross-section view of module 9 having a structure 205 between module bottom 210 and grade 215. It also illustrates a prior art mechanical mount 229. Structures 205 meet the definition of “structure” because they are either solid below the contact surface 240 or the volume beneath the contact surface 240″ constrains air movement”. Prior art mechanical mount 229 does not meet the definition of structure because the volume of space beneath and perpendicular to the contact surface 240 is not filled with material from the object, or the material from the object contained in the bounding volume does not constrain air movement.

FIG. 4 shows a side view of prior art mechanical mount 229. It has bracket 230, which has an ell shape that touches grade 215. It also has rectangular bar bracket 235. FIG. 5 demonstrates that rectangular bar bracket 235 extends along the bottom of module 9, while L-bracket 230 extends only a portion of the length of rectangular bar bracket 235. FIG. 5 has free air or unconstrained air at arrow 220.

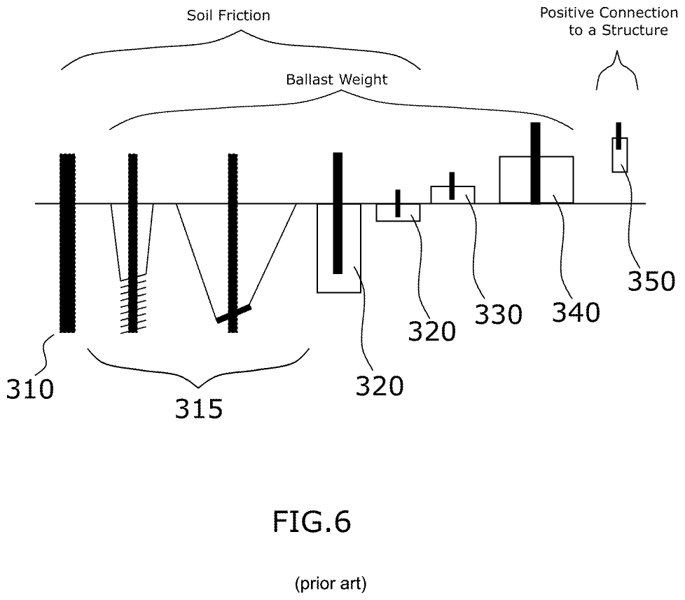

Some versions of T-mounted arrays resist wind loads of up to 194 mph without using any prior art methodologies illustrated in FIG. 6. Prior art arrays that connect to the ground or another structure using an object such as pier 310 rely on soil friction to secure the arrays. Prior art arrays that use objects such as ballasted piers 315 or buried ballast piers 320 use a combination of soil friction and ballast weight to secure the prior art array. Prior art arrays that use small ballasted piers 330 or large ballast piers 340 essentially rely on ballast weight alone to secure the prior art array. Finally, prior art arrays that connect to an architectural object, such as shown by positive connection 350, essentially use a special case of ballast weight or perhaps soil friction methodologies to secure the prior art module.

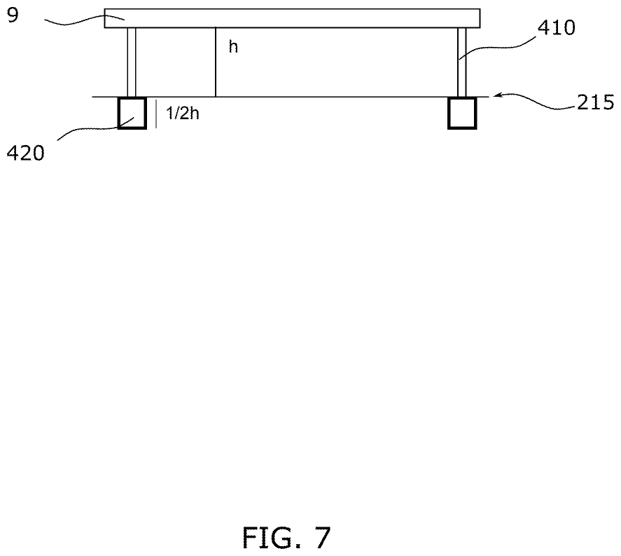

In some versions, T-mounted systems disclosed in this document are mounted at a height, h, of less than 100, 75, 50, or 20 cm above grade on objects that extend into the ground less than one-half of the height. This is schematically illustrated in FIG. 7. FIG. 7 shows module 9 on a support object 410 at a height, h, above grade 215. It shows buried object 420 having a depth of one-half times h. In some versions in which support object 410 and buried object 420 are rigidly or semi-rigidly connected, buried object 420 represents a point and distance into the ground as per the definition above.

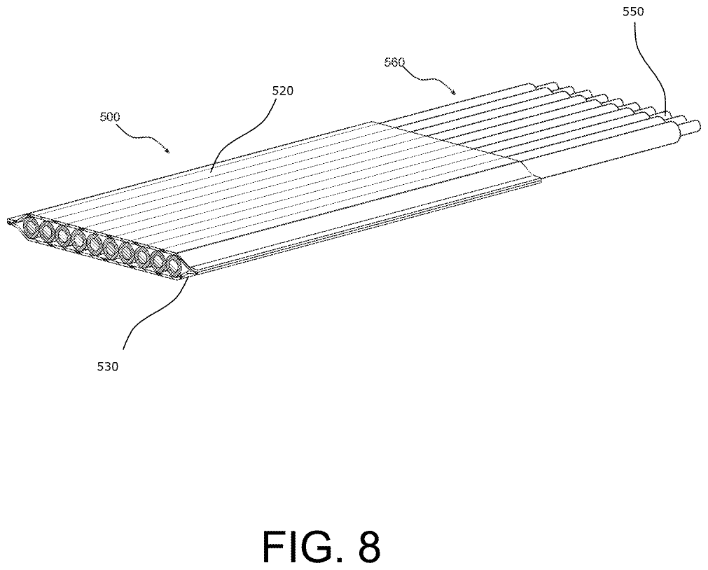

FIG. 8 depicts LCA 500, a pre-assembled DC power harness with a delaminated region 560. Delaminated region 560 is a region in which upper sheet 520 and lower sheet 530 of the laminate have been cut or peeled back, leaving cables 550 unlaminated. In some implementations, delaminated region 560, not having laminate around cables 550, allows cables 550 to fit through conduit or other cable runs or cable passageways.

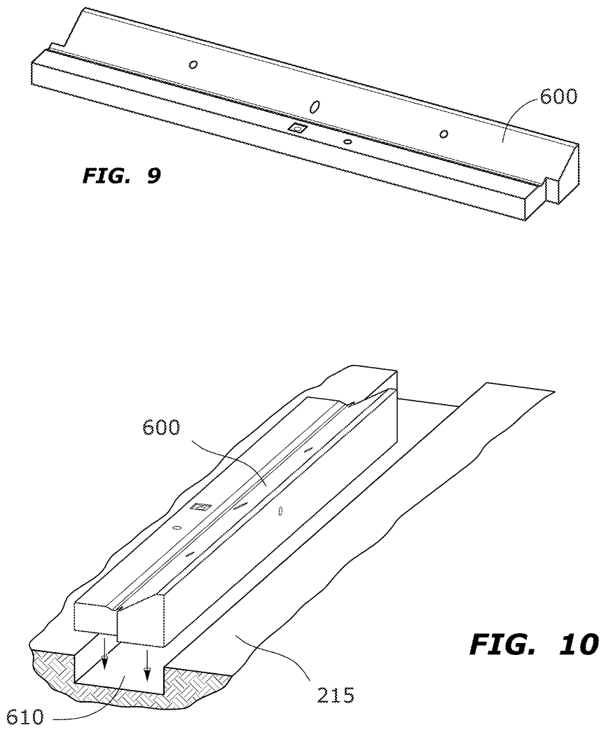

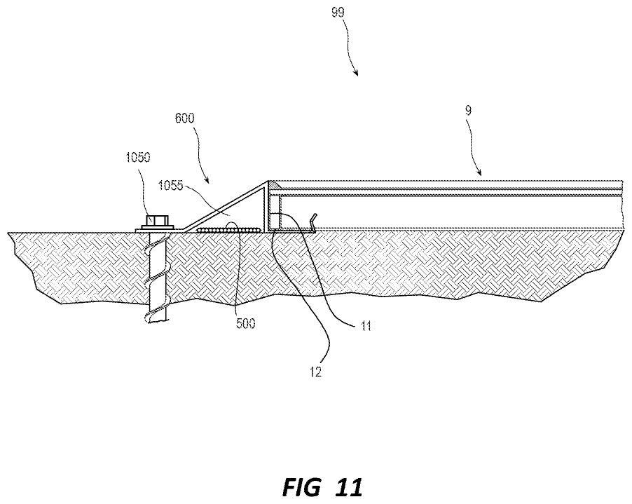

FIG. 9 shows a view of a leading-edge unit 600. Details of curb member 600 appear in U.S. patent application Ser. No. 17/153,845, which is incorporated by reference. FIG. 10 shows a version in which curb member 600 sits in a depression 610 in the ground 215. FIG. 11 shows a variation of curb member 600 positioned against edge 12 of an array of modules 9. FIG. 11 also shows a cavity 1055 that receives LCA 500 (FIG. 8), module 9, and frame 11. Other versions sometimes use bolts 1050 or other connectors extending through frame 11, leading-edge units 600, or both.

Curb member 600 can be made of any convenient, low-cost material, such as concrete, metal, plastic, rubber, recycled plastic, recycled rubber, or other material. Curb member 600 serves to retard the movement of modules 9 along the edges 12. In some versions, curb member 600 also directs surface water over the tops of modules 9, which reduces soil washout and module lifting caused by rising or flooding surface water. Additionally, causing surface water to flow over the tops of modules 9 has some benefits in keeping modules 9 clean. Curb member 600 is also useful in installations using corner brackets or other brackets.

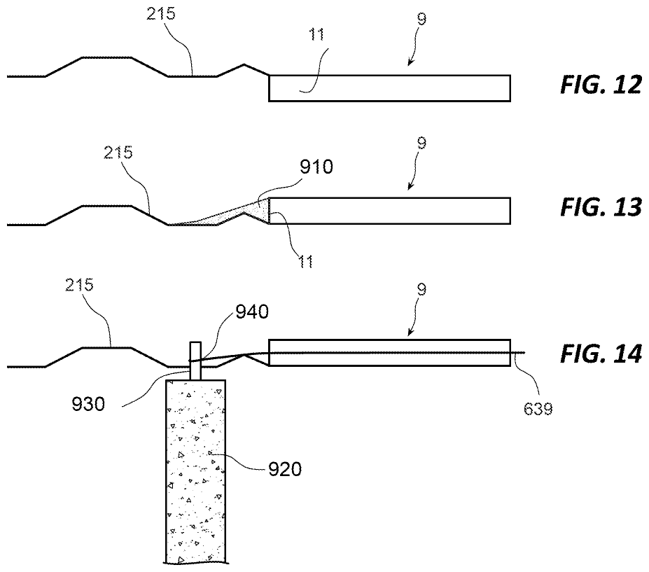

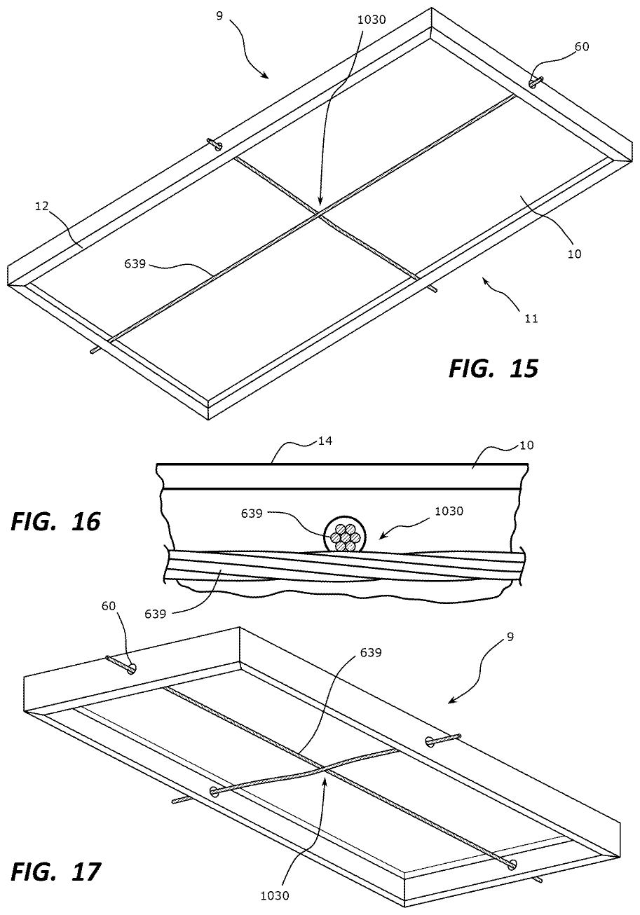

FIGS. 12-14 depicts alternate methods to achieving the leading-edge units' effects, including placing a module 9 flush with grade 215, piling aggregate base 910 up to the top of frame 11, and supplying a pier 920 and post 930 (having a cable attachment 940) foundation without an aggregate base 910.

In some versions, the T-mounted system mounts the solar panels directly to the earth without an intermediate structure between the modules and the earth itself.

FIG. 15 shows a perspective view of module 9 comprising a module frame perimeter. FIG. 15 also shows the underside of substrate 10. The figure shows cable 639 extending along module 9 for the entire module row or column length. Crossover 1030 is an intersection of the “X-direction” and “Y-direction” of cable 639. FIG. 16 is a magnified view of crossover 1030 in cross-section. The cross-section cut is parallel to cable 639 offset from crossover 1030.

FIG. 17 is a perspective view of module 9 from a different angle than FIG. 15. It also shows cable openings or penetrations 60. The cable interacts with module 9 through a hole or penetration 60 in module 9 or a module clip that sometimes contains a similar penetration 60.

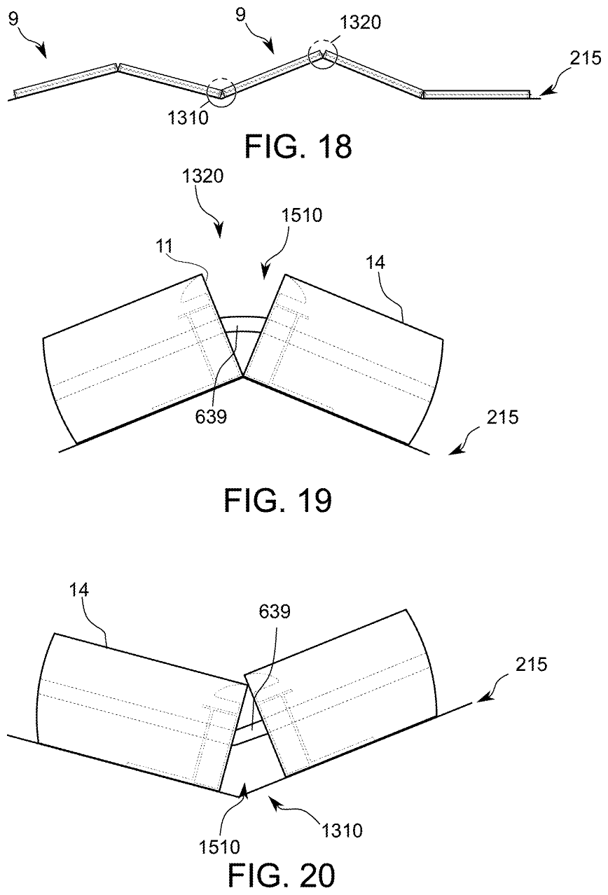

FIG. 18 is a side view of several modules from a row of modules. 9, aligned with connecting cable 639, having upper gap 1320 and lower gap 1310. FIG. 19 shows a magnified view of a joint or abutment between two modules 9 having lower gap 1310. FIG. 19 shows a magnified view, like that of FIG. 18, but having upper gap 1320. Both FIG. 19 and FIG. 20 show frame 11. FIG. 18, FIG. 19, and FIG. 20 depict the modules shown sitting on a non-flat, earth or ground surface and illustrate the ability of connecting cable 639 to accommodate adjacent modules 9 sitting at different angles. As shown, despite adjacent panels sitting at different angles, cable 639 retains the top edge of each panel or the top surface of each panel at substantially the same height or position. In some implementations, cable 639 maintains the height of the modules near enough to allow an autonomous robotic cleaning system to operate on the array. In some implementations, cable 639 maintains the height of adjacent modules 9 within 0.25, 0.5, 1, 2, or 3 inches of each other.

Connecting cables 639 create a mesh network of flexible mechanical connections 1510 between adjacent solar modules 9, strings of modules, and rows of modules making up larger array 99. The connecting cables 639 and grade 215 align modules 9 in the X, Y, and Z axes creating a meshed array of modules 9 through frame holes 60. The nature and location of alignment holes 60 in frame 11 allow the system to align the top faces of module 9 with its surrounding modules. Flexible mechanical connections 1510 enable the array to follow the earth's natural contour or grade 215. Flexible mechanical connections 1510 help prevent damage to modules 9 from the differential settlement of soils that may occur over time within the boundary of array 99.

The connecting cable 639 results in a meshed array where every module 9 directly or indirectly connects to many other modules 9 in the array 99. The network limits the total vertical or horizontal shift that may occur through module expansion, contraction, and differential soil settlement over time. Modules 9 are constrained yet free-floating within the boundaries of array 99.

The arrangement of modules strung together with the connecting cable creates essentially a zero module-to-module row spacing REQUIREMENT as there will be no shading throughout the array due to low, Z-axis module-to-module variability. Additionally, the connecting cable 639 creates an array 99 with no parts or pieces to penetrate the earth's surface inside of the array 99. The interconnected mesh network of modules resists uplift forces through the combined weight of the solar array and its leading-edge unit 600, resulting in a flexible and abatable anchoring system. Wire rope includes corrosion-resistant materials and is hidden beneath the solar panel surfaces. Other versions use non-metallic cable or rope.

As discussed above, modules 9 and connecting cable 639 follow the contour of the ground (grade 215). These cables 639 maintain a module-to-module edge alignment. In some versions, cables 639 maintain modules 9 flat, such as flat enough for an autonomous cleaning robot to move from module to module. Array 99 may have rows with greater than 25 or 50 modules and columns with greater than 6, 17, 14, 29, or 50 modules. In some versions, connecting cable 639 lays diagonally across the array. In some versions, the connecting cable 639 extends along rows of modules, columns of modules, or both.

Leading edges line the array on at least one side in some versions.

In some versions, connecting cable 639 may be anchored at an end of, both ends of, one or more midpoints along, or one or more midpoints along and one or both ends of the connecting cable 639. For instance, the connecting cable can attach to curb members 600.

A further advantage of mounting the modules on or just above the ground is that cooling from the backside of the modules' surface is easily accomplished. Cooling techniques can include, by way of non-limiting example, evaporative cooling, alternate high-emissivity coatings, adding air vents on the edge of the module frame, and adding various enhanced heat-transfer materials and or methods. Reducing the operating temperature by increasing cooling increases the modules' effective energy production rate. In addition, earth positioning avoids heating from indirect sunlight and ground exposed to sunlight. Also, the ground beneath the modules is more of a heat sink. In some implementations, the modules have a dark or heat-transmitting coating on their back or underside to promote radiant heat transfer to the ground or airspace beneath the modules.

A variety of techniques can accomplish ventilation of the backside. By way of non-limiting example, outlet vents can connect to one or more vertical stacks to use convection to remove warm air. Or fans can cool the modules as needed. Inlet vents can use separate supply tubing or louvers cut into frames 11.

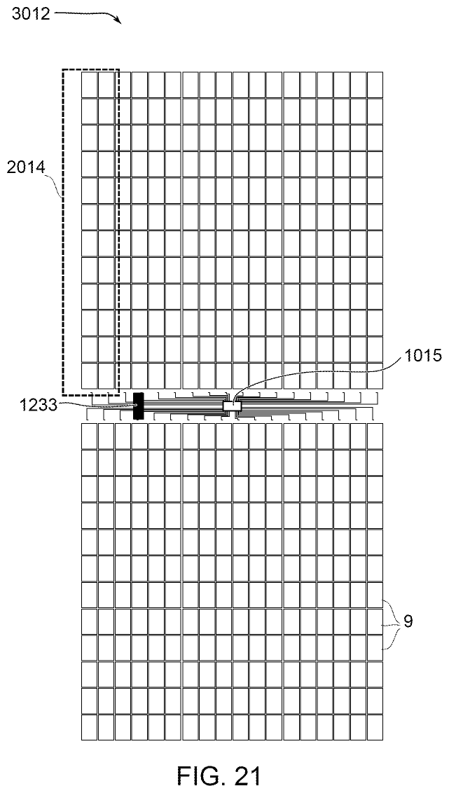

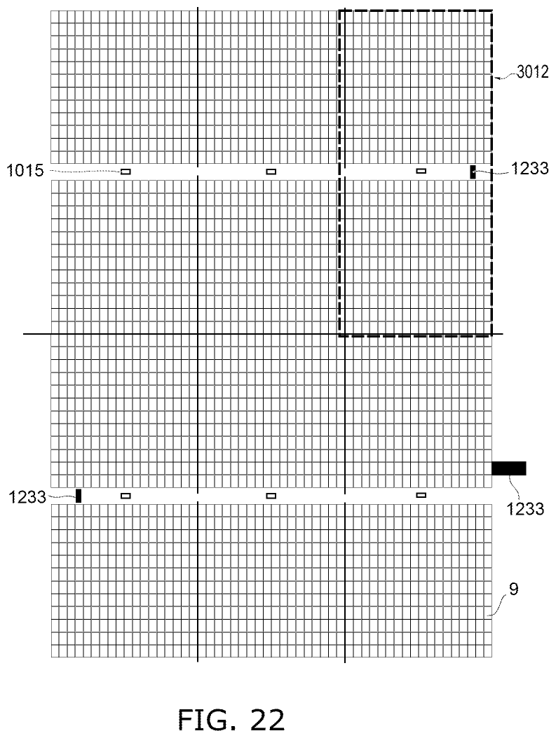

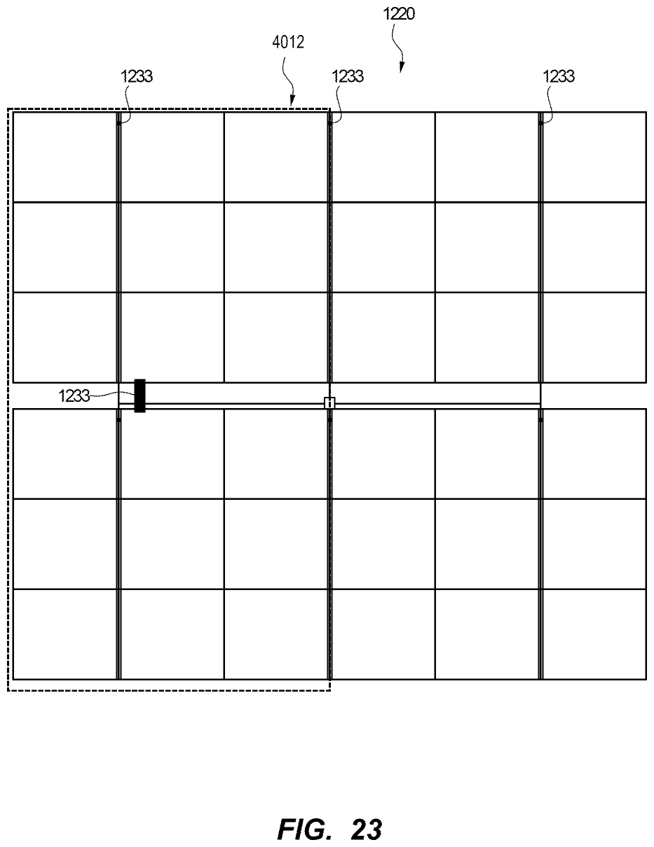

FIGS. 21-23 are schematic diagrams showing a solar array layout for a commercial solar power plant. FIG. 21 shows a first block 3012 comprising 18 strings 2014 with a DC-AC inverter 1015 depicted in the center (having 432 modules). FIG. 22 shows a second block 4012 having six of first block 3012 (2592 modules). FIG. 23 shows eighteen of second block 4012 (46656 modules), an implementation of a utility-scale plant. Some utility-scale solar power plant implementations have one or more of these arrays.

### Cleaning

T-mount systems facilitate more economical module cleaning. Robotic cleaning systems for operation on T-mount systems are much simpler than such robotics systems for cleaning racked systems. Since T-mounted systems are substantially flat, cleaning T-mounted systems with autonomous robotics systems is far more economical than cleaning racked systems.

To facilitate robotic cleaning, T-mount implementations used connectors to minimize module-to-module z-axis variability. Another way to facilitate robotic cleaning is to provide bridges between separate module sections or separate module arrays. These bridges allow the robot to cross from one section or array to another.

While cleaning is more critical for T mounting modules, using low-cost automated cleaning costs significantly less on T mounting arrays than it does on rack-mounted arrays for a similar cleaning cadence. Non-cleaned arrays have soiling reductions for fixed-tilt (typically 6%) and trackers (typically 3.5%) arrays that are higher than cleaned T mounting arrays (typically less than 1%).

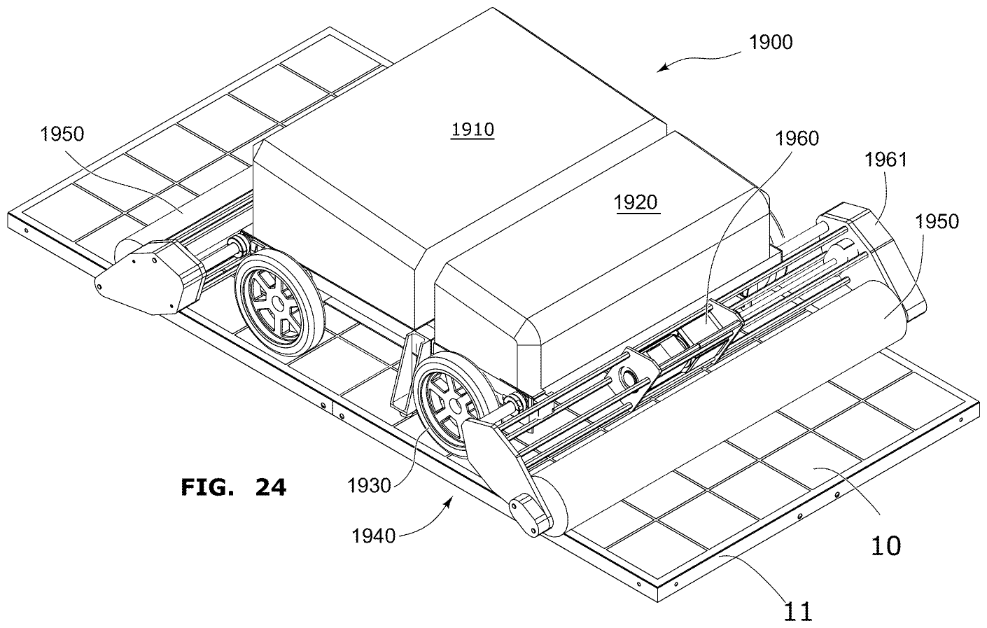

FIG. 24 depicts an autonomous cleaning robot 1900. Autonomous cleaning robot 1900 comprises rear cover 1910, front cover 1920, and wheels 1930. Depending upon the implementation, robot 1900 uses two or more, three or more, for more, six or more, or eight or more wheels 1930. The implementation depicted in FIG. 24 shows the robot with two brush assemblies 1940, but the cleaning nature of robot 1900 only requires a single brush assembly 1940. Assembly 1940 comprises brush 1950, brush motor 1960, and other components connecting brush assembly 1940 to robot 1900. Brush assembly 1940 connects to the chassis of robot 1900 and, in some implementations, has two pieces a front chassis 2030 and a rear chassis 2020. Brush motor 1960 drives the rotation of brush 1950 through a transmission 1961.

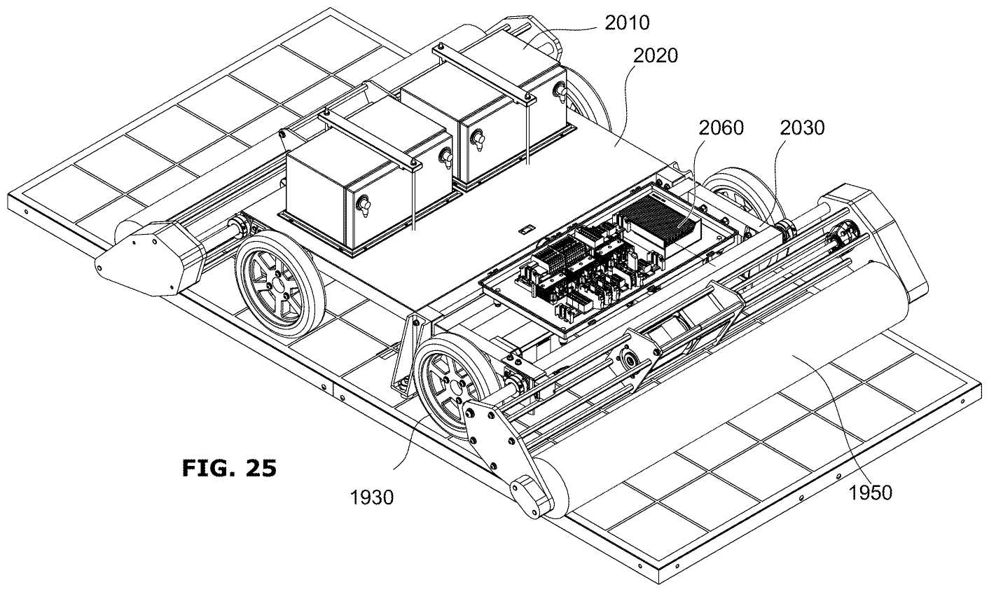

FIG. 25 depicts a perspective view of robot 1900 sitting on module 9. As shown, robot 1900 has wheels 1930, brush assembly 1940, brush 1950, battery 2010, rear chassis 2020, front chassis 2030, and electronic assembly 2060.

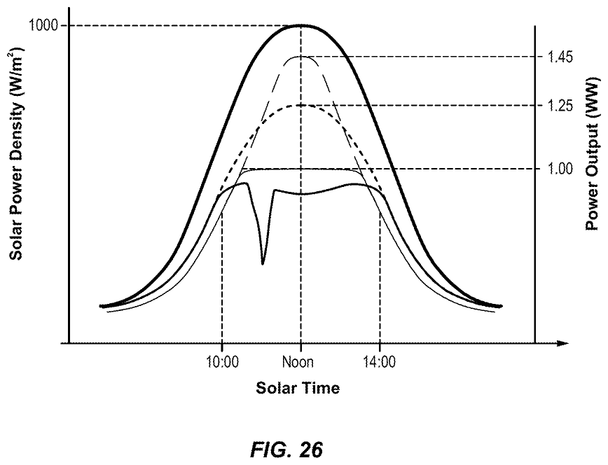

FIG. 26 is a graph showing a sample output for a single, clear-sky day at the plant. The horizontal axis represents time; specifically, a sample of daylight hours from roughly 7 AM to roughly 7 PM, where the graph peak represents solar noon. The vertical axis on the left represents the available sunlight or solar insolation, as measured in watts per meter squared (W/m²) or the typical amount of energy available from the sun during a given day. The curve (peak at 1000 W/m²) represents a typical day of sunlight. The noon peak is solar noon, not the 12 o'clock hour. The right vertical axis indicates the AC power output and the DC power potential of the plant in megawatts. And the two lower curves represent the actual AC power output. The curve characterized by the double hump is typical of a tracker-type plant, with a maximum delivered power of 1 MW (in this example). The sharp dip in the tracker curve represents clouds shading the tracker. The other lower curve represents the earth-oriented power plant power curve with a maximum delivered power of 1 MW. The two-lines extending above the power curves represent the additional available DC power. The smaller of the two curves, which peaks at 1.25, is the tracker power plant, while the taller curve, peaking out at 1.45, is the earth-oriented power plant.

In some versions, the AC power output is intentionally limited for practical reasons, mostly related to the grid's power absorption rate. Therefore, the AC power output shows a flat peak at 1.00 MW on this graph. The excess power is either not used or applied to alternative uses such as energy storage. It is possible to use the additional energy to support the grid in volt-ampere reactive units (VARs) or other power functions other than direct increases in power output (MW). Alternatively, the excess power can be purchased as surplus power by the grid utility or transported across the grid for use at a remote location.

An economic advantage of the T-mounted arrangement of the modules results from the relative economics of the DC power generation components instead of the plant's total operating cost. As depicted in FIG. 26, the two power curves have an arbitrary limit of 1 MW. The utility company that buys the power sets this limit. This limit depends on the utility company's power needs at the interconnection point of the plant and cannot be exceeded by contract or design. The available DC power from a T-mounted plant is greater than the available DC power from a tracker plant of similar AC capacity, as is depicted in FIG. 26. This fact results from a difference in power plant design, function, and economics. The T-mounted plant has more available DC power because it uses more modules for the same AC size. The T-mounted plant has an intrinsic advantage over the tracker and fixed-tilt plant because it can contain more DC as a percentage of the design AC output. The additional DC power in the power plant has value. This is true for any solar plant with a DC:AC ratio greater than 1.0. Since it cannot be used to deliver Real power to the grid (which would result in revenues for the power plant owner), it is maintained as Potential power, waiting to be dispatched. There are multiple ways to capture this value.

During periods of intermittent cloud cover, the clouds may only cover some modules. The rest of the modules produce full power. Potential power allows the plant to ride through lower light conditions from clouds while still delivering 100% of the AC power plant capacity allowed by the grid connection. The plant can ride through more significant or slower-moving clouds without dropping below 100% capacity if there is greater DC power.

The utility operator receiving real power from the power plant can use the Potential power to provide supplemental voltage and frequency regulation by adjusting the power factor from the connected inverters. Modern solar power operators sell this portion of the Potential power in VARs to the utility. The additional DC power of the earth-oriented plant brings additional VARs available to be sold compared to a typical plant of like AC capacity.

Batteries or other energy storage or conversion means can save the Potential DC power from the plant to sell as Real energy to the grid or for other valuable uses when the sun is unavailable. The additional DC power of the earth-oriented plant generates more sellable energy than a typical plant of like AC capacity.

FIGS. 21-23 are schematic diagrams showing a solar array layout for a commercial solar power plant.

FIG. 21 shows a string array comprising 18 strings with a string inverter depicted in the center. The inverter 1015 connects to the strings to convert the DC power from the strings to AC power. FIG. 22 further expands FIG. 21 to show six string arrays further co-located to one another. FIG. 23 further expands FIG. 22 shows a complete solar array 1220 comprised of 18 string arrays, 18 string inverters, 324 strings, and a single medium voltage transformer that receives power from the six sets of three series-connected string inverters. A utility-scale solar power plant typically comprises one or more of these arrays.

### Cleaning

T-mounted systems facilitate more economical module cleaning. Robotic cleaning systems for operation on S0 systems are much simpler than such robotics systems for cleaning racked systems. Since T-mounted systems are substantially flat, cleaning T-mounted systems with autonomous robotics systems is far more economical than cleaning racked systems.

To facilitate robotic cleaning, T-mounted implementations used connectors to minimize module-to-module Z-axis variability. Another way to facilitate robotic cleaning is to provide bridges between separate module sections or separate module arrays. These bridges allow the robot to cross from one section or array to another.

While cleaning is more critical for T-mounted modules, using low-cost automated cleaning costs significantly less on T-mounted arrays than it does on rack-mounted arrays for a similar cleaning cadence. Non-cleaned arrays have soiling reductions for fixed-tilt (typically 6%) and trackers (typically 3.5%) arrays that are higher than cleaned T-mounted arrays (typically less than 1%).

### Bridges

FIGS. 21-23 show a technique of using bridges 1233 to connect between separated portions in an array and between different arrays. These bridges allow automatic cleaning across array gaps or multiple arrays.

### Definitions (for Purposes of this Disclosure)

A “module” is the photovoltaic media, PV wire connections to the media, and any support, such as frames, that the module manufacturer adds to the media. Modules range from 100-850 watts to 1-4 m³.

“Array” is a grouping of multiple modules, some of which are next to three separate modules. In some implementations, an array has greater than 5, 10, 15, 20, 30, 40, 50, 60, 70, 80, 90, or 100 columns of modules. In some implementations, an array has greater than 5, 10, 15, 20, 30, 40, 50, 60, 70, 80, 90, or 100 rows of modules. In some implementations, an array has more than 50, 100, 200, 400, 600, or 800 modules. Sometimes, rows or columns have two or more modules. Module-to-module spacing for site-oriented systems can be much, much closer. In some implementations, module-to-module spacing in a T-mounted system ranges from 0.1 300 mm, 10-200 mm, 1-50 mm, or 1-25 mm.

“Contiguous” or “adjacent” modules, rows, or columns means modules, rows, or columns having a spacing of less than 30, 20, 10, or 5 cm “Conterminous” means that each member of a group or grouping is next to at least one other member.

“No favored orientation” means that the array is oriented with respect to a geographic feature on the site, e.g., river, stream bed, canyon, hill, etc. In some embodiments, the array is not oriented with respect to the sun's direction. “Geographic feature” includes legal property lines but does not include latitude, longitude, or the orientation of impinging sunlight. Systems with no favored orientation are sometimes called earth or topography oriented. Azimuth independent means independent of the orientation of the sun with respect to the module's latitude.

In some implementations, “earth-mounted” refers to a group of greater than 50, 100, 200, 400, 600, 800, 1000, or 1500 modules in which at least 80 percent of the modules have at least one contact point, as defined below, that rests on the ground or rests on a contact surface of one or more structures, provided that the portion or portions of the structure or structures encompassed by the volume of space beneath and perpendicular to the contact surface is solid or constrains air movement.

In some versions, “contact points” are regions of a module that touch the ground or touch a contact surface. In some versions, “contact points” are regions of a module that touch the ground without intervening regular structure or are regions of a module that touch the ground without intervening manufactured structure.

“Contact surfaces” are structure portions that touch a contact point. In some implementations, the volume perpendicular to the contact surface between the contact surface and the ground does not have free air. In some implementations, an object that does not have “free air” is an object that does not contain constrained air. In some versions, a contact surface defines a starting point of a path that is continuous and ends at a point of the structure touching the ground and directly beneath the contact surface.

In some implementations, the volume perpendicular to the contact surface between the contact surface and the ground constrains air movement. In some versions, “constrains air movement” means constrains lateral air movement. In some implementations, an object that “constrains air movement” bounds a volume of air on at least two lateral sides. In some implementations, “constrained air” is air constrained on at least two lateral sides in addition to the top and bottom.

For purposes of this disclosure and depending upon the implementation, “utility-scale” means having one or more of the following characteristics: a total DC output of greater than 200, 300, 400, 500, 600, 700, 800, 900, 1000, 1100, 1200, 1300, 1400, 1500, 1600, 1700, or 1800 V; or a total DC power output of greater than 100, 200, 500, 700, 1000, 2000 kW.

In some implementations, “earth-mounted” means any flat mounting substantially parallel to the earth or ground that places the plane of the array within a short distance above the ground. This disclosure sometimes uses “ground-mounted” as a synonym for “earth-mounted”. In some versions, “flat” means horizontally flat and substantially parallel to the earth. In some implementations, a “ground module” is an earth-mounted module.

In some implementations, “ground level” is the level of the ground immediately before module installation.

“Ground” or “native topography” is the surface of the site and includes material naturally present at the site and material added to the site by human activity at any time before the first module is placed. In some implementations, “Ground” or “native topography” is the surface of the site and includes material naturally present at the site and irregularly shaped material added to the site by human activity at any time before placing the first module. In some implementations, “Ground” or “native topography” is the surface of the site and includes material naturally present at the site and material added to the site by human activity at any time before placing the first module, provided that the largest dimension of 80% of the material is less than 20 cm.

“Structure” is any material added to the site or brought onto the site that occupies any of the space between a module and the ground and does not include manufacturer support. “Structure” is support for the module not installed by the panel manufacturer during production.

Perpendicular and parallel are defined with respect to the ground's local tangent plane.

“Plane of the array” is the average of the planes for each individual module in the array.

“Robotic cleaning device” is an air-pressure-based, a water-pressure-based, a vacuum-based, a brush-based, or a wiper-based device for cleaning modules.

“Autonomous” means performed without manual intervention or undertaken or carried out without any outside control. An “autonomous robotic device” is a robotic cleaning device that operates to clean modules without real-time human control. An “autonomous robotic device” is sometimes used synonymously for a “fully autonomous cleaning robot”. An AI autonomous robotic device is an autonomous robotic device that contains hardware and software that observes its own cleaning performance and adjusts its performance algorithms based on those observations.

In some implementations, “operates to clean modules” includes initiating a cleaning cycle.

A “cleaning cycle” is a complete cleaning of a section of modules from start to finish. In some implementations, a cleaning cycle includes the robotic device leaving its resting pad or structure, traveling to a section of modules, cleaning each module of the section, and traveling to another section of modules or returning to the resting pad or structure.

“Cleaning period” is 6, 12, 24, 36, 48, 60, 72, 84, 96, 108, 120, 132, or 144 hours.

“Module-to-module z-axis variability” or “module-to-module elevation difference”—is a measure of the largest elevation difference between the highest point at a module edge and the lowest point of an adjacent edge of an adjacent module. The “z-axis” extends from the module face and points substantially vertically.

In some implementations, when used to describe an array, “smooth”, “smoothed”, “flat”, or “flattened” means smooth or flat enough or made smooth or flat enough such that the height difference or the module-to-module z-axis variability between adjacent modules is small enough that a fully autonomous cleaning robot can move from one module onto another. The maximum module-to-module z-axis variability in some implementations is less than 4, 3, 4, 1, or 0.5 inches. In some implementations, when used to describe the ground, “smooth”, “smoothed”, “flat”, or “flattened” means smooth or flat enough or made smooth or flat enough such that the height difference or the module-to-module z-axis variability between adjacent modules in an array installed on the ground is small enough that a fully autonomous cleaning robot can move from one module onto another.

“Low module elevation” is defined as an elevation of a module that is low enough to prevent upward forces caused by air movement across the module from lifting a module from the array, whether the array comprises mechanical components to resist module lifting or not. In some implementations, a low module elevation is defined as an elevation of a group of modules that is low enough that air-caused upward forces on the group are too small to lift the group. In some implementations, low module elevation is an elevation of less than 100 cm, 0 to 90 cm, 0 to 80 cm, 0 to 70 cm, 0 to 60 cm, 0 to 50 cm, 0 to 40 cm, 0 to 30 cm, 0 to 20 centimeters, or 0 to 10 cm measured from the ground to a lower edge of the module or, in edge-less module systems, from the ground to the module surface.

“Intermediate distance” is defined as from 0-1 m, 0-70 cm, 0-60 cm, or 0-50 cm. “Short distance” is defined as 0-49.9 cm, 0-30 cm, 0-20 cm, or 0-10 cm.

“Mechanical stow functionality” is functionality that changes the direction that a tracker-based system points the modules to minimize the effect of winds on the system. This minimizes the danger of high winds damaging the tracker or the installed modules.

“Extreme dampening functionality” is functionality that dampens mechanical oscillations in a tracker-based system caused by high winds to minimize the danger that those winds will damage the tracker or the installed modules.

“Connectors” are structures that connect modules. In various implementations, connectors can be mechanical connectors, electrical connectors or electrical interconnects, or both. “Electrical interconnects” are DC electrical connections between modules.

“Flexible connections” or “flexibly connected” are or describe connections made with rigid or non-rigid connectors that allow the angle between a plane of a module and of an adjacent module to vary without breaking the connection.

“Joints” are any permanent or semi-permanent connection between the joined components.

A “high DC:AC” voltage ratio is greater than 1.0-2, 1.1-1.9, 1.2-1.8, and 1.3-1.7.

What is claimed is:

1. A photovoltaic power plant comprising a utility-scale group of modules wherein a group of modules contains greater than 800 conterminous PV modules in which more than 80% of the modules are earth-mounted.

2. The plant of claim 1 comprising two groups of modules.

3. The plant of claim 2 comprising greater than 1600 conterminous modules.

4. The plant of claim 1 comprising eight groups of modules.

5. The plant of claim 4 comprising an inverter with an AC output, wherein
the array has a DC output,
and
the DC:AC ratio is 1.2-1.9, 1.4-1.9, or 1.6-2.2.

6. The plant of claim 5 comprising 200 inverters.

7. The plant of claim 6, wherein one of the arrays has 50 or more rows of modules.

8. The plant of claim 7, wherein one of the arrays has 50 or more columns of conterminous modules.

9. The plant of claim 8 further comprising a fully autonomous cleaning robot.

10. The plant of claim 2 further comprising a fully autonomous cleaning robot.

11. The plant of claim 10 wherein the fully autonomous cleaning robot is an AI autonomous robotic device.

12. The plant of claim 11, wherein some of the modules have a contact region that rests on the ground or rests on a contact surface of one or more structures,
provided that the volume beneath and perpendicular to the contact surface is solid or constrains air movement.

13. The plant of claim 1, wherein at least one group does not connect to an inverter.

14. The plant of claim 1, wherein at least one group does not connect to an inverter with an AC output.

15. The plant of claim 14 having an arrangement that withstands wind speeds of greater than 150 mph.

16. The plant of claim 15 not containing stowing functionality or extreme dampening functionality.

17. The plant of claim 1 not containing stowing functionality or extreme dampening functionality for modules or groups of modules.
